(19) United States
(12) Patent Application Publication
(10) Pub. No.: US 2008/0299341 A1
(43) Pub. Date: Dec. 4, 2008

(54) Three-Dimensional Laminate Used To Provide A Rubber-Based Glove, Method For The Manufacture Thereof And Glove

(76) Inventors: Michel Renaud, Paris (FR); Colette Crepeau, Paris (FR)

Correspondence Address: CLARK & BRODY, 1090 VERMONT AVENUE, NW, SUITE 250, WASHINGTON, DC, 20005, US

(21) Appl. No.: 11/665,495

(22) PCT Filed: Oct. 12, 2005
(86) PCT No.: PCT/FR2005/002525

§ 371 Date: Apr. 9, 2008

(30) Foreign Application Priority Data
Oct. 18, 2004 (FR) 0410992

(51) Int. Cl. B32B 25/10; B29C 33/00; B29C 41/14; A41D 19/00

(52) U.S. Cl. 428/36.1; 264/257; 264/222; 264/152; 264/442; 2/167

(57) ABSTRACT

The invention relates to a three-dimensional laminate which can be used to make a rubber-based glove with improved transversal extensibility and elasticity, a method for the manufacture thereof, and said glove which is water-tight and also tight in relation to most household liquids. The inventive laminate defines an internal volume and comprises an internal support and at least one external rubber layer which adheres to said support. The internal support comprises an elastic non-woven structure.

The present invention relates to a three-dimensional laminate which can be used to form a rubber-based glove possessing improved transverse extensibility and improved transverse elasticity, to a process for its manufacture and to such a glove, which in particular is leaktight toward water and toward the majority of household liquids.

Rubber-based gloves intended to protect the hands from contact with household liquids are very widespread commercially. These gloves can be divided into two categories according to whether they are of unsupported type, being composed of rubber and having their internal face smooth or coated with flock, or else of supported type, comprising at least one external rubber layer adhering to a support usually composed of a knitted textile.

Typically, the internal face of the unsupported gloves can be coated with powder or flock, which dries out the skin of the hands and can release undesirable allergens into the air, or else chlorinated, which renders these gloves difficult to pull onto sweaty hands and does not contribute to the protection of the environment due to the presence of chlorine.

With regard to supported gloves, they are generally manufactured by means of coating by dipping a knitted textile into a bath of liquid rubber.

Experience shows that the gloves obtained by flocking exhibit a relatively limited ability to absorb perspiration and are in addition liable to release allergens conveyed by the free flock. Furthermore, it turns out that textiles, such as knitted cotton fabrics, lend themselves poorly to coating with a fine layer of rubber by dipping due to their relatively porous structure.

Attempts have been made in the past to use nonwoven structures in place of the abovementioned knitted structures in the manufacture of rubber-covered gloves.

The patent document U.S. Pat. No. 4,359,783 discloses a glove obtained by coating a textile support with rubber using a knife or by dipping in a bath based on this rubber. This support is formed of an internal nonwoven which is based on short fibers of wool or of a thermoplastic polymer and which is rendered integral by needling these short fibers with an external knitted textile, such as a knitted fabric made of cotton or of a thermoplastic polymer, so that these short fibers project out of the layer of rubber in order to obtain a rough external surface.

A major disadvantage of this glove lies in the blocked extensionable nature which is conferred by the nonwoven used and in its relatively high overall thickness, which is conferred in particular by the knitted textile. The result thereof is that this glove exhibits a reduced extensibility and a reduced elasticity in the direction of its width and that it is not capable of conferring a satisfactory dexterity and a satisfactory tactile sensitivity on its user.

One aim of the present invention is to overcome this disadvantage and this aim is achieved in that the Applicant Company has discovered, surprisingly, that a three-dimensional laminate delimiting an internal volume and comprising an internal support which comprises a specifically elastic nonwoven structure, said laminate comprising at least one external rubber layer adhering to said internal support, can advantageously be used to form a glove possessing improved transverse extensibility and improved transverse elasticity.

It should be noted that a three-dimensional laminate according to the present invention is preferably composed of a piece of clothing which matches the outline of a part of the human body and, more preferably still, of a glove, which can, for example, be of the type:
comprising five housings respectively intended to receive the five fingers of a hand, it being possible for this glove to be of an anatomical type (i.e., designed to specifically receive either the right or left hand of a user) or else of ambidextrous type (i.e., suitable for receiving without distinction either hand of the user), or else
comprising from two to four housings which are each intended to receive from one to four fingers (e.g., gloves of mitten type).

In the present description, the term “nonwoven structure” is understood to mean any laminated or nonlaminated structure based on nonmetal materials comprising at least one nonwoven, which nonwoven can be defined as follows from the standard ISO 9092 of 1988. It is a manufactured sheet composed of a ply or of a web of directionally or randomly oriented fibers which are bonded together by friction and/or cohesion and/or adhesion, with the exception of paper and products obtained by knitting, weaving, cutting or stitching, incorporating bonding yarns or filaments, or which are felted by wet fulling, whether or not these are needle-bonded. This nonwoven can be based on natural or chemical fibers which can be noncontinuous fibers or continuous filaments or can be formed in situ.

According to the invention, the term “elastic nonwoven structure” is understood to mean a nonwoven structure, the elasticity properties of which are conferred, according to preference, by:
the process for producing a nonwoven, for example by water-jet bonding and texturing coupled to chemical bonding, by a process of thermal contraction of the fibers of the nonwoven or by a creping process known under the name “Micrex”,
the intrinsically elastic characteristics of a nonwoven based on fibers composed of one or more elastomer(s), or
laminating, preferably by hot calendering, so as to obtain spot laminating, one or more elastic nonwoven(s) with another nonelastic nonwoven or else with an elastic web, such as an elastomer film or mesh.

According to another characteristic of the invention, said laminate exhibits a continuous external face which is composed of said external rubber layer, unlike the glove laminates known from the abovementioned document U.S. Pat. No. 4,359,783.

According to another characteristic of the invention, said elastic nonwoven structure surrounds the whole of said internal volume (i.e., for a glove, this nonwoven structure is positioned continuously facing the whole of the internal face of the glove intended to cover the palm and the back of the hand), and it is advantageously devoid of any stitch.

Advantageously, this laminate according to the invention is such that said elastic nonwoven structure exhibits, in a “cross” direction (i.e., perpendicular to a “machine” direction):
an elongation at break equal to or greater than 200% and more advantageously still equal to or greater than 250%, and
a breaking force equal to or greater than 1 kg.

It should be noted that these very high values for elongation at break and for breaking force in the cross direction confer an improved transverse extensibility and an improved transverse elasticity on the laminate according to the invention, such as a glove.

Also advantageously, said laminate is such that said elastic nonwoven structure exhibits, in the “machine” direction:
an elongation at break of equal to or greater than 30%, and
a breaking force equal to or greater than 8 kg.

The elongations at break and breaking forces of the nonwoven structure which are mentioned in the present description were all measured according to the standard JIS L 1085 on straight test specimens with a length of 75 cm and a width of 5 cm.

Said nonwoven structure according to the invention can comprise:
natural fibers, such as cotton, and/or
artificial fibers (i.e., manufactured from naturally existing products which have been subjected to chemical conversions in order to obtain a textile material), such as viscose, and/or
synthetic fibers (i.e., manufactured completely chemically from coal or oil derivatives) based on at least one elastomer, such as a polyurethane, and/or based on at least one thermoplastic polymer of textile or nontextile type, such as a polyamide, a polyester or a polyolefin, such as a polypropylene.

According to a first embodiment of the invention, said nonwoven structure comprises at least one elastic nonwoven.

Advantageously, said or at least one of said elastic nonwoven(s) according to the invention is an elastic nonwoven based on elastomer fibers composed of polyurethane.

According to alternative embodiments of the invention, it is possible, for example, to use the following fibers in order to obtain the elastic nonwoven:
(i) bicomposite fibers:
   in the form of yarns of the type comprising an elastomer core, for example composed of a polyurethane or of a polyester rubber, and a thermoplastic sheath, for example composed of a polyamide, of a polyester or of a polyolefin, as described in the patent documents U.S. Pat. No. 5,352,518 and JP-A-61 194221, or
   conjugated elastic fibers comprising a first component composed of a crystalline polypropylene and a second component composed of another thermoplastic polymer, such as a low density polyethylene, as described in the patent document JP-A-62 184 118, or
   composite fibers comprising a first component composed of a crystalline polypropylene and a second component composed of a thermoplastic elastomer, such as an ethylene/α-olefin copolymer obtained by means of a metallocene catalyst, as described in the patent document JP-A-09 291 454; or else
(ii) a blend of essentially nonelastic short fibers and of bicomposite short fibers comprising hard nonelastic fibers and elastomer fibers, as described in the patent document U.S. Pat. No. 3,353,345; or else
(iii) fibers based on linear interpolymers or copolymers of ethylene and of at least one α-olefin, as described in the patent document WO-A-94/25648.

According to a preferential characteristic of this first form, said or each elastic nonwoven is obtained by a melt-blown process applied to at least one elastic polymer (i.e., homopolymer or copolymer), for example a polyurethane, which comprises the following stages:
(i) extruding and spinning said elastic polymer,
(ii) drawing into microfilaments in an air jet at high speed and high temperature,
(iii) cooling and forming the nonwoven web on a perforated roll or belt and applying a vacuum.

According to an alternative embodiment of this first form, said or each elastic nonwoven is obtained by another physical process for gathering together fibers by melting or else by a chemical process for gathering together by bonding. Mention may be made, for example, of a hydroentangling process.

According to one exemplary embodiment of this first form, said nonwoven structure comprises, laminated onto said elastic nonwoven, at least one nonelastic nonwoven which is, for example, based on thermoplastic fibers, such as fibers of a polyester (e.g., a polyethylene terephthalate).

According to a second embodiment of the invention, said nonwoven structure comprises two nonelastic nonwovens which are, for example, each based on thermoplastic fibers, such as fibers of a polypropylene, and which are laminated onto the respective faces of an elastomer film or of an elastomer mesh or of an elastic nonwoven, such as a film based on a polyurethane elastomer, on an ethylene/vinyl acetate copolymer or on a thermoplastic elastomer.

According to another characteristic of the invention, said elastic nonwoven structure according to the invention is optionally subjected to a finishing treatment, such as a microcreping or a texturing.

Advantageously, said laminate according to the invention, such as a glove, is such that said internal support exhibits a thickness of less than or equal to 400 μm and more advantageously still of less than or equal to 300 μm, which contributes to further improving the characteristics of dexterity and of tactile sensitivity for the user of this glove.

Said laminate according to the invention, such as a glove possessing improved transverse extensibility and improved transverse elasticity, is capable of being manufactured by various processes employed using a mold suitable for receiving and shaping said laminate, such as a hand-shaped mold.

Mention may be made, for example, without any implied limitation, of:
a process for dipping a mold covered with said internal support into a rubber-based liquid bath in order to obtain said or each external rubber layer adhering to said internal support;
a process for overmolding said or each rubber layer in an injection mold comprising said internal support;
a process for sheathing said or each rubber layer over a mold covered with said internal support by thermal contraction of this layer; or
a process for adhesively bonding said internal support to a mold covered with said or each rubber layer, by dipping the rubber-covered mold in a bath of adhesive, and then turning inside out the laminate separated from the mold.

According to a preferred exemplary embodiment of the invention, said laminate can be obtained by employing the abovementioned process of dipping a mold covered with said internal support in a rubber-based liquid bath, this process essentially comprising the following successive stages:
(i) a three-dimensional support defining an internal volume is prepared, said support comprising an elastic nonwoven structure;
(ii) an external outline of a mold; such as a hand-shaped mold, is covered with the support obtained in (i) so that said support matches said outline;
(iii) the support positioned in (ii) is subjected to dipping in at least one liquid bath based on a dispersion of rubber in an aqueous or nonaqueous solvent in order to bring about adhesion of said dispersion to said support covering said mold;
(iv) said or each dispersion of rubber covering said support is dried in order to obtain said laminate, which comprises at least one layer of crosslinked rubber adhering to said support; then
(v) said laminate is recovered by separating it from said mold.

Said or each dispersion of rubber used in the above stage (iii) is composed of a crosslinkable or at least partially crosslinked rubber composition which is intended to constitute said or each external rubber layer of said laminate. This rubber composition for external layer(s) is based on at least one elastomer and it can comprise a crosslinking system such as a sulfur vulcanization system or else a crosslinking system based on a peroxide and optionally on sulfur or else it can be based on an elastomer comprising heat-crosslinkable groups or alternatively on an already crosslinked thermoplastic elastomer, such as a TPE.

Said or each elastomer can be any diene or nondiene elastomer which can be used in rubber-based gloves and is preferably chosen from the group consisting of natural rubbers, synthetic polyisoprenes, butadiene/acrylonitrile copolymers, butadiene/acrylonitrile/methacrylic acid terpolymers, polychloroprenes, isoprene/isobutylene copolymers, carboxylated or noncarboxylated styrene/butadiene copolymers, polyurethanes, ethylene/vinyl acetate copolymers and thermoplastic elastomers, such as copolymers comprising styrene blocks, thermoplastic elastomers derived from polyolefins or thermoplastic polyurethanes.

The rubber composition according to the invention also comprises, in addition to said or each elastomer and optionally said crosslinking system (which comprises, in a known way, a vulcanization accelerator and a vulcanization activator in the preferred case of crosslinking with sulfur), all or a portion of the additives commonly used in the manufacture of rubber-based gloves, such as antiaging agents, for example antioxidants, pigments or thickeners.

It should be noted that the dipping operation which is applied in said preferred exemplary embodiment of the invention to said elastic nonwoven structure which has been three-dimensionally shaped (i.e., by matching the outline of said mold) makes it possible not only to confer on the laminate obtained, such as said glove, an improved transverse extensibility and an improved transverse elasticity but also to render this laminate leaktight toward water and toward the majority of household liquids.

According to another characteristic of the invention, stage (i) comprises the following stages:
(ia) a two-dimensional blank of said support comprising said elastic nonwoven structure is prepared; then
(ib) said blank is cut out and welded by following an outline of a template predefined in connection with that of said mold.

Preferably, stage (ia) comprises, according to said first form, laminating an elastic nonwoven onto at least one nonwoven based on thermoplastic fibers or else, according to said second form, laminating two nonwovens based on thermoplastic fibers onto the respective faces of an elastomer film or of an elastomer mesh or of an elastic nonwoven as indicated above, in order to obtain said two-dimensional blank.

Preferably again, stage (ib) is carried out using ultrasound. According to an alternative embodiment of the invention, this stage (ib) is carried out using a heating hollow punch. According to a second alternative embodiment of the invention, this stage (ib) is carried out using chemical adhesive bonding.

According to another characteristic of the invention, stage (iii) can comprise chemical or thermal coagulation of the rubber layer or layers, in particular in order to obtain gloves with a length of greater than 25 cm.

A glove according to the invention comprises said laminate as defined above, and said or each external layer of this glove is composed of said crosslinked rubber composition. It should be noted that this glove exhibits an improved transverse extensibility and an improved transverse elasticity.

According to another characteristic of the invention, said glove comprises at least two housings which are each intended to receive one or more fingers and said housings each exhibit a three-dimensional external face possessing a convex surface.

According to another advantageous characteristic of the invention, said glove comprises five housings each intended to receive a finger and said housings are connected in pairs to one another via a substantially saddle-shaped concave surface, which contributes to providing satisfactory dexterity to the user of said glove.

Advantageously, the force required to elongate said glove by 100% in the direction of its width is less than 2 N and more advantageously still this force is less than 1.5 N.

According to another characteristic of the invention relating to the production of said glove, said elastic nonwoven structure, for example composed of a laminated material as defined above, exhibits a weight per unit area or grammage of greater than 50 g/m² and preferably of between 75 and 100 g/m².

Advantageously, the weight per unit area of said glove according to the invention incorporating this elastic nonwoven structure is less than 300 g/m².

Preferably, said glove according to the invention exhibits a total thickness of less than 500 μm and more preferably still of less than 450 μm, which contributes to improving the dexterity of its user.

Preferably again, this glove according to the invention is in accordance with said preferred example of the abovementioned first embodiment, said elastic nonwoven structure comprising an elastic nonwoven, for example based on fibers of a polyurethane elastomer, which is laminated onto at least one nonwoven based on thermoplastic fibers, such as fibers of a polyester, in such a way that this nonwoven based on thermoplastic fibers defines the whole of an internal face of said glove surrounding said internal volume.

It should be noted that this internal nonwoven, advantageously based on polyester fibers, provides the user of the glove thus obtained with a satisfactory feeling of comfort.

The abovementioned characteristics of the present invention, and others, will be better understood on reading the following description of an exemplary embodiment of the invention, given by way of illustration and without limitation.

### EXAMPLE

A glove according to the invention was manufactured by carrying out the following stages.

### 1. Preparation of a Three-Dimensional Glove Support:

### 1.1 Preparation of a Two-Dimensional Blank for the Support:

A support composed of a nonwoven structure sold by Kuraray under the name “WM086” was used as two-dimensional blank. This support is of two-layer type obtained by a melt-blown process, comprising an elastic nonwoven based on fibers of a polyurethane elastomer which is laminated onto a nonelastic nonwoven based on fibers of a polyester.

This two-dimensional support blank exhibits a weight per unit area of 86 g/m² and a thickness of 260 μm.

The elongations at break and the breaking forces of straight (rectangular) test specimens with a length of 75 cm and a width of 5 cm resulting from this nonwoven support were measured according to the standard JIS L 1085:

| | |
|---|---|
| breaking force: | 9.2 kg in the “machine” direc- |
| | tion |
| | 2.0 kg in the “cross” direc- |
| | tion; and |
| elongation at break: | 40% in the “machine” direction |
| | 285% in the “cross” direction. |

### 1.2 Formation of a Three-Dimensional Support:

The two-dimensional blank thus obtained was subjected to cutting-welding by ultrasound while following the outlines of a specific template. It should be noted that the same result might be obtained using a heating hollow punch suited to the dimensions of this template or else using chemical adhesive bonding.

The template was designed so as to obtain optimum covering of the hand-shaped mold and this template was placed on the surface of the blank for the nonwoven support, this surface being folded double in thickness so that the faces based on elastic fibers made of polyurethane are positioned against one another.

A three-dimensional support for a glove possessing five housings respectively intended to receive the five fingers of a hand was thus formed.

This support was subsequently positioned on the hand-shaped mold composed of glazed porcelain which had been preheated beforehand. More specifically, said support was turned inside out beforehand so that the face formed of said nonelastic nonwoven made of polyester matches the outline made of porcelain of said mold.

2. Dippings of the Support which Covers the Mold in Rubber:

Various dippings were carried out in order to cover, with layers of rubber, the external face of the support formed of said elastic nonwoven made of polyurethane, by successively carrying out the following stages:
dipping the mold thus covered in a coagulating solution of calcium nitrate in water;
drying the coagulant thus deposited on the support;
dipping the mold covered with the support thus treated in a bath based on natural latex comprising in particular a sulfur vulcanization system and an antioxidant;
further dipping in a bath based on natural latex comprising in particular a sulfur vulcanization system and an antioxidant, in order to obtain a finishing layer;
washing, by means of immersing in water, the wet gel thus obtained on the support covering the mold;
drying-vulcanizing, in an oven, the mold covered with the support thus obtained;
withdrawing from the mold the glove according to the invention thus obtained; and
postvulcanizing this glove in an oven (or in a drum dryer).

It should be noted that this dipping in rubber of the nonwoven support which covers said mold is such that the rubber does not completely coat the fibers constituting said support.

The structural and mechanical characteristics of the glove according to the invention thus obtained are presented in the table below, in comparison with those of a known glove of the state of the art which has been obtained by coating with rubber a textile support composed of a knitted raw cotton fabric.

The following were measured:
the thicknesses and the weights per unit area of the elastic nonwoven support according to the invention, of the known support made of knitted raw cotton fabric and of the two gloves respectively incorporating these supports, and
the forces necessary to elongate the glove according to the invention and the known glove by 100% in the direction of their length and by 100% in the direction of their width (abbreviated to F100_{length} and F100_{width})

| | Rubber glove | Rubber glove |
|---|---|---|
| Characteristics of | comprising a | comprising a known |
| the supports and of | nonwoven support | woven support |
| the gloves | according to the | (knitted cotton |
| incorporating them | invention | fabric) |
| Thickness of the | 0.260 | 0.510 |
| support (mm) | | |
| Thickness of the | 0.390 to 0.440 | 0.595 to 0.630 |
| glove (mm) | | |
| Weight per unit | 82 | 129 |
| area of the support | | |
| (g/m²) | | |
| Weight per unit | 257 | 361 |
| area of the glove | | |
| (g/m²) | | |
| F100_{length} glove (N) | 1.6 to 1.8 | 13.1 to 14.5 |
| F100_{width} glove (N) | 1.2 to 1.3 | 2.8 to 2.9 |

It should be noted that the vulcanized rubber coating possessed by the glove according to the invention is such that the force necessary to elongate this coating in isolation by 100% is approximately 0.2 N.

This table shows in particular that the elastic nonwoven support according to the invention exhibits a thickness and a weight per unit area which are greatly reduced in comparison with those of the textile support made of knitted cotton fabric, which makes it possible to substantially improve the dexterity of the user of this glove according to the invention.

This table also shows that this elastic nonwoven support confers, on the glove according to the invention, an improved longitudinal and transverse flexibility in comparison with that which this textile support confers on the known glove incorporating it.

It should be noted that the only very slightly porous structure of the nonwoven support according to the invention lends itself well to the production by dipping of a fine rubber coating, thus conferring, on the glove obtained, improved leaktightness toward water and toward the majority of household liquids, and an advantageously reduced weight.

It should also be noted that the glove according to the invention, which is reinforced by this elastic nonwoven support, exhibits a satisfactory mechanical strength and that, according to the abovementioned exemplary embodiment of the invention, the process of covering the hand-shaped mold with the three-dimensional nonwoven support of the invention, followed by one or more dippings of the mold thus “covered”, makes this glove very comfortable in use, this comfort being additionally increased owing to the fact that the internal face of said glove is composed of the nonelastic nonwoven made of polyester.

1. A three-dimensional laminate delimiting an internal volume, it being possible for said laminate to be used to form a glove possessing improved transverse extensibility and improved transverse elasticity and said laminate comprising an internal support and at least one external rubber layer adhering to said support, characterized in that said support comprises an elastic nonwoven structure.

2. The laminate as claimed in claim 1, characterized in that it exhibits a continuous external face which is composed of said external rubber layer.

3. The laminate as claimed in claim 1, characterized in that said nonwoven structure surrounds the whole of said internal volume.

4. The laminate as claimed in claim 1, characterized in that it is obtained using a mold suitable for receiving and shaping said laminate, such as a hand-shaped mold.

5. The laminate as claimed in claim 1, said nonwoven structure exhibiting a machine direction and a cross direction, characterized in that said nonwoven structure exhibits, in said cross direction, an elongation at break, measured according to the standard JIS L 1085, which is equal to or greater than 200%.

6. The laminate as claimed in claim 5, characterized in that said nonwoven structure exhibits, in said cross direction, an elongation at break, measured according to the standard JIS L 1085, which is equal to or greater than 250%.

7. The laminate as claimed in claim 1, characterized in that said nonwoven structure comprises at least one elastic nonwoven, such as a nonwoven based on fibers of a polyurethane elastomer.

8. The laminate as claimed in claim 7, characterized in that said nonwoven structure additionally comprises at least one nonwoven based on thermoplastic fibers, such as fibers of a polyester, which is laminated onto said elastic nonwoven.

9. The laminate as claimed in claim 1, characterized in that said nonwoven structure comprises two nonwovens based on thermoplastic fibers, such as fibers of a polypropylene, which are laminated onto the respective faces of an elastomer film or of an elastomer mesh or of an elastic nonwoven, such as a film based on a polyurethane elastomer, on an ethylene/vinyl acetate copolymer or on a thermoplastic elastomer.

10. The laminate as claimed in claim 1, characterized in that said internal support exhibits a thickness of less than or equal to 400 μm.

11. The laminate as claimed in claim 1, characterized in that said or each layer of rubber is composed of a rubber composition based on at least one elastomer chosen from the group consisting of natural rubbers, synthetic polyisoprenes, butadiene/acrylonitrile copolymers, butadiene/acrylonitrile/methacrylic acid terpolymers, polychloroprenes, isoprene/isobutylene copolymers, carboxylated or noncarboxylated styrene/butadiene copolymers, polyurethanes, ethylene/vinyl acetate copolymers and thermoplastic elastomers.

12. The laminate as claimed in claim 1, characterized in that it is leaktight toward water and toward household liquids.

13. A process for the manufacture of a laminate as claimed in claim 1, characterized in that it essentially comprises the following successive stages:
(i) a three-dimensional support defining an internal volume is prepared, said support comprising an elastic nonwoven structure;
(ii) an external outline of a mold, such as a hand-shaped mold, is covered with the support obtained in (i) so that said support matches said outline;
(iii) the support positioned in (ii) is subjected to dipping in at least one liquid bath based on a dispersion of rubber in an aqueous or nonaqueous solvent in order to bring about adhesion of said dispersion to said support covering said mold;
(iv) said or each dispersion of rubber covering said support is dried in order to obtain said laminate, which comprises at least one layer of crosslinked rubber adhering to said support; then
(v) said laminate is recovered by separating it from said mold.

14. The manufacturing process as claimed in claim 13, characterized in that stage (i) comprises the following stages:
(ia) a two-dimensional blank of said support comprising said elastic nonwoven structure is prepared; then
(ib) said blank is cut out and welded by following an outline of a template predefined in connection with that of said mold.

15. The manufacturing process as claimed in claim 14, characterized in that stage (ia) comprises laminating an elastic nonwoven onto at least one nonwoven based on thermoplastic fibers or else two nonwovens based on thermoplastic fibers onto the respective faces of an elastomer film or of an elastomer mesh or of an elastic nonwoven, in order to obtain said two-dimensional blank.

16. The manufacturing process as claimed in claim 14, characterized in that stage (ib) is carried out using ultrasound.

17. The manufacturing process as claimed in claim 14, characterized in that stage (ib) is carried out using a heating hollow punch.

18. The manufacturing process as claimed in claim 14, characterized in that stage (ib) is carried out by chemical adhesive bonding.

19. The manufacturing process as claimed in claim 13, characterized in that said dispersion is a dispersion in water of a rubber composition based on at least one elastomer chosen from the group consisting of natural rubbers, synthetic polyisoprenes, butadiene/acrylonitrile copolymers, butadiene/acrylonitrile/methacrylic acid terpolymers, polychloroprenes, isoprene/isobutylene copolymers, carboxylated or noncarboxylated styrene/butadiene copolymers, polyurethanes, ethylene/vinyl acetate copolymers and thermoplastic elastomers.

20. The manufacturing process as claimed in claim 13, characterized in that stage (iii) comprises chemical or thermal coagulation of said rubber layer or layers.

21. A glove possessing improved transverse extensibility and improved transverse elasticity, characterized in that it comprises a laminate as claimed in claim 1.

22. The glove as claimed in claim 21, said glove comprising at least two housings each intended to receive one or more fingers, characterized in that said housings each exhibit a three-dimensional external face possessing a convex surface.

23. The glove as claimed in claim 22, said glove comprising five housings each intended to receive a finger, characterized in that said housings are connected in pairs to one another via a substantially saddle-shaped concave surface.

24. The glove as claimed in claim 21, characterized in that the force required to elongate said glove by 100% in the direction of its width is less than 2 N.

25. The glove as claimed in claim 21, characterized in that it exhibits a thickness of less than 500 μm.

26. The glove as claimed in claim 21, characterized in that said elastic nonwoven structure comprises an elastic nonwoven, such as a nonwoven based on fibers of a polyurethane elastomer, which is laminated onto at least one nonwoven based on thermoplastic fibers, such as fibers of a polyester, in such a way that said nonwoven based on thermoplastic fibers defines the whole of an internal face of said glove surrounding said internal volume.
